(19) United States
(12) Patent Application Publication
(10) Pub. No.: US 2021/0077849 A1
(43) Pub. Date: Mar. 18, 2021

(54) SMART PULLEY

(71) Applicant: Vertimax, LLC, Tampa, FL (US)

(72) Inventor: Michael A. Wehrell, Tampa, FL (US)

(21) Appl. No.: 17/018,519

(22) Filed: Sep. 11, 2020

Related U.S. Application Data
(60) Provisional application No. 62/899,834, filed on Sep. 13, 2019.

(51) Int. Cl. A63B 21/00; F16H 55/36; A63B 24/00; A63B 71/06; A63B 21/055

(52) U.S. Cl. CPC A63B 21/154; F16H 55/36; A63B 24/0062; A63B 71/0619; H02J 7/0042; A63B 2220/51; A63B 2225/50; A63B 2209/08; A63B 2220/24; A63B 21/0557

(57) ABSTRACT

A system for use in exercise having a flexible member which passes over a pulley. Sensors produce output which is used by a processor to compute the velocity of the pulley and distance travelled by the flexible member. A force sensor and a level sensor connected to the pulley produce outputs which are used to compute the tension applied to the flexible member. Data related to the use of the system computed using the outputs is displayed for the user. The system can produce performance information related to the use of the device. The system can be self-contained in a housing or output can be delivered to a remote device for computing, storage and display.

### CROSS-REFERENCE TO RELATED APPLICATIONS

This Application claims the benefit of U.S. Provisional Application 62/899,834 filed on Sep. 13, 2019.

### FIELD OF THE INVENTION

The invention relates to exercise equipment and more particularly to exercise equipment having one or more pulleys whereby elastic bands or non-elastic cables pass over the pulleys.

### BACKGROUND OF THE INVENTION

Many exercise devices today apply resistive loads to trainees utilizing elastic bands or non-elastic cables (flexible member) that pass over one or more pulleys before connecting to and transferring the training load to the trainee. The vast majority of these exercise devices have no electronic measurement means to measure and record any exercise performance parameters related to the trainee's exercise performance which could be valuable to measuring training performance, progress and effectiveness both near and long term. The purpose of the invention is to provide the means whereby the invention can easily replace a referenced pulley in the said exercise devices or simply be added to a flexible member that transfers a training load to a trainee so that the invention may measure and record as a function of time, parameters associated with the trainee's exercise movement which include (a) the training load applied to the trainee, (b) the distance of the training movement which defined by the distance the trainee moves the “distal training end of the flexible member” (DTEFM) applying the load, and (c) the velocity of the DTEFM throughout the complete training movement. The device using the measured data will be able to actively communicate with the trainee to instruct them during training drills or sessions while calculating valuable exercise performance parameters to present or display in real time or store for future analysis enabling the trainee's exercise performance and progress over time to be tracked and evaluated to better determine both the trainee's physical improvement and the effectiveness of the exercise protocols being implemented.

### SUMMARY OF THE INVENTION

A novel device comprising a housing with mount so that it may be connected to a stationary object. The housing having a rotatable pulley mounted whereby the rotatable pulley (pulley) receives a flexible member and is adapted to be rotated by the flexible member which has one distal end anchored and the opposing DTEFM attached to a trainee whereby the pulley rotates in one direction when the trainee moves the DTEFM away from the invention and the pulley rotates in the opposite direction when the trainee moves DTEFM towards the invention. The housing having a rotational sensor for measuring the speed of rotation of the pulley and an internal processing unit with timer connected to the rotational sensor so that the rotational velocity as well as complete and partial rotations of the pulley can be continuously measured in the clockwise or counterclockwise direction. The ability of the rotational sensor to measure the speed of rotation of the pulley will enable the invention to calculate the velocity and acceleration characteristics of the DTEFM for any training movement. The housing will additionally have a tension sensor connected to the mount for measuring the total force applied to the pulley resultant from the flexible member which applies two equal load vectors to both sides of the pulley where it enters and exits the pulley.

Referencing FIG. 14, the device may include a level sensor mounted in the housing to produce an output representative of the angle of the housing's center axis F3ₘₑₐₛ with respect to a horizontal axis such that the processing unit receiving the level sensor output can compute a training load vector F1 along the line of travel of that portion of the flexible member between pulley and the DTEFM so that the angle between force vector F1 and F3ₘₑₐₛ axis can be resolved. Using the resolved angle Theta₁ and the tension measured by the tension sensor along the F3ₘₑₐₛ axis, the training load force along vector F1 to be calculated.

The device may additionally have a communication module for transmitting all measurement data from the processing unit to a display which may be embedded in the housing and/or reside on a device separate from the invention. The communication module may have wireless communication capabilities so that all measured data can be transmitted from the invention's processing unit to a remote processor such as a smart phone, iPad, laptop or PC to process, display and store for future analysis.

For rotation detection of the pulley, one or more magnetic targets may be placed on the pulley while utilizing magnetic sensors embedded in the housing to detect the direction and velocity of the magnetic targets as well as complete and partial pulley rotations in either the clockwise or counterclockwise direction.

The device will contain a power source such as a battery and a charging device wherein the charging device is adapted to react to the movement of the magnetic targets on the pulley thereby creating an electrical current for the purpose of charging the battery.

When using an “elastic flexible member” (EFM), it is not enough to just measure pulley rotations to determine how far the DTEFM has moved away from the device because as the EFM is extracted by the trainee, the tension will increase on all portions of the EFM between the invention and trainee due to the EFM's finite length. Hence, all said portions of the EFM will elongate due to the increased tension and the invention's pulley will not be able to react and detect the band elongation since the physical distortion is occurring between the pulley and the DTEFM. Hence, the actual distance trained will be greater than what the pulley detects based on multiplying the circumference of the invention's pulley times the number of complete and fractional rotations counted as the trainee moved the DTEFM away from the device. The undetected band distortions in band length will lead to measurement errors in both distance trained and training velocity. There will be numerous ways the device with a processing unit or a remote processor wirelessly receiving data from the invention's communication module will be able to account for EFM elongation and shrinkage between the invention's pulley and DTEFM such that when combined with rotational pulley data, will increase the measurement accuracy of the distance trained as a function of time when the trainee and DTEFM is moving away from or towards the device.

To improve the distance trained measurements, the device can implement a look up table containing the elasticity coefficient for the EFM indicating how much force is required to elongate a reference length of the EFM to various percentages of the reference length. For example a 5 pound pull stretches the EFM 10% relative to the relaxed length of the reference length, a 10 pound pull stretches it 20%, a 60 pound pull stretches it 100% of the relaxed length etc. The processing unit using the timer, rotational pulley velocity from the rotational sensor and elasticity coefficient data will be able to account for a large percentage of the undetected band elongation and/or shrinkage between the pulley and DTEFM to increase the accuracy of training distance calculations as a function of time allowing the velocity of the DTEFM to be accurately calculated at any instant in time during the training movement.

Multiple calibration methods for the device will be able to be quickly and easily and implemented by the trainee whereby the calibration methods will enable the device to calculate the distance trained by the trainee without the need for an elasticity coefficient table related to the flexible member being monitored by the invention. A second device with the ability to communicate training load measurements to the fixed invention can be used to calibrate and reduce measurement errors associated with the fixed invention's measured training distance and training load applied to the trainee.

The pulley may be interchangeable whereby the pulley groove on the interchangeable pulley is physically adapted to accommodate a flexible member of specific diameter so that slippage between the pulley and flexible member is minimized since any slippage between the flexible member and pulley would result in distance trained errors due to the pulley losing track of the flexible member's movement during slippage.

### BRIEF DESCRIPTION OF THE DRAWINGS

FIG. 1 shows an example of a current art that uses nonelastic flexible members (NEFM) to transfer exercise force to a trainee.

FIG. 2 shows the FIG. 1 art modified with the device 20 replacing pulley 2 to monitor exercise parameters associated with tension in the NEFM and movement of the NEFM.

FIG. 3 shows an example of a current art that uses an elastic flexible members (EFM) to transfer exercise force to a trainee.

FIG. 4 shows the FIG. 3 art modified with the device 20 replacing pulley 2 to monitor exercise parameters associated with tension in the EFM and movement of the EFM.

FIG. 5 presents a current art utilizing a retractable, elongated elastic flexible member confined in a small housing which allows trainees to exercise over longer distances without large increases in band resistance as the EFM is extracted and stretched.

FIG. 6 shows the FIG. 5 art modified with the device 20 replacing pulley 2 to monitor exercise parameters associated with tension in the EFM and movement of the EFM.

FIG. 7 shows a variation of the FIG. 1 art with the device 20 placed in a different location additionally illustrating force vectors and distance trained measurements.

FIG. 8 illustrates force vectors acting on the device and example of a distance trained measurement when utilized with the FIG. 5 art.

FIG. 9 illustrates force vectors acting on the device and an example of a distance trained measurement when the invention is utilized with a prior art whereby the trainee can exercise over much longer training distances with a retractable EFM.

FIG. 10 shows a top lengthwise view of the device 20 embodiment utilizing a pulley 23 rotatably mounted to a housing and connected mounting device 22.

FIG. 11 shows a sideview of the device 20 with display 28, control buttons 29A-29C and rotational sensors 24A and 24B.

FIG. 12 presents the device 20 with a transparent housing 21 illustrating electronic components and connectivity between the components and processing unit 25.

FIG. 13 illustrates the recharging components of device 20 less many of the components of FIG. 12 for clarity.

FIG. 14 illustrates how the training load F1 applied to the trainee will be calculated from a measured tension along the F3ₘₑₐₛ axis and two measured congruent flexible member 3 exit angles Theta 1 and Theta 2.

FIG. 15 illustrates how a spring-loaded lever 37 attached to the housing 21 would function to locate the edge of flexible member 3 to determine the exit angle of flexible member 3 relative to reference axis Y.

FIG. 16 illustrates how a spring-loaded lever of device 20 would interact with an integrated flexible member 3 to determine flexible member 3's exit angle Theta₁ relative to the reference axis Y.

FIG. 17 shows how the invention utilizes a removable pulley to allow the flexible member to be easily integrated to the device 20.

FIG. 18 shows how the flexible member 3 is inserted into the pulley slot prior to pulley 23 being re-inserted to complete the flexible member integration.

FIG. 19 shows the completion of the integration process with flexible member 3, pulley 23 and retention pin 26 inserted into the device 20.

FIG. 20 illustrates a top view of the device 20 after flexible member 3 integration into the device has been completed.

FIG. 21 shows an example of how the invention's pulley may have a groove with a custom shape to accommodate a flexible member diameter of a specific size.

FIG. 22 shows another example of how the pulley groove may be shaped for flexible member 3 to maximize friction between flexible member 3 and pulley 23 so that slippage between pulley 23 and flexible member 3 can be minimized.

FIG. 23 provides illustration for a discussion in the Specification on how the portion of an elastic flexible member (EFM) between B1 and B2 will elongate (stretch) while the trainee is moving the distal training end of the flexible member (DTEFM) away from the device.

FIG. 24 provides illustration for a discussion in the Specification on how the portion of an elastic flexible member (EFM) between B1 and B2 will shrink (contract) while the trainee is moving the distal training end of the flexible member (DTEFM) towards the device.

FIG. 25 shows which way pulley 23 will rotate given the illustration orientation when the distal training end of the flexible member moves away from the device.

FIG. 26 shows which way the pulley 23 will rotate given the illustration orientation when distal training end of the flexible member moves towards the device.

FIG. 27 illustrates a procedure to calibrate the invention in order to reduce measurement error with respect to distance trained when using an elastic flexible member (EFM) and thus improve the accuracy of the calculation of the velocity of the DTEFM.

FIG. 28 illustrates a second procedure whereby errors in both calculating distance trained and the training load F1 applied to the trainee are calibrated for minimum measurement error when using an EFM.

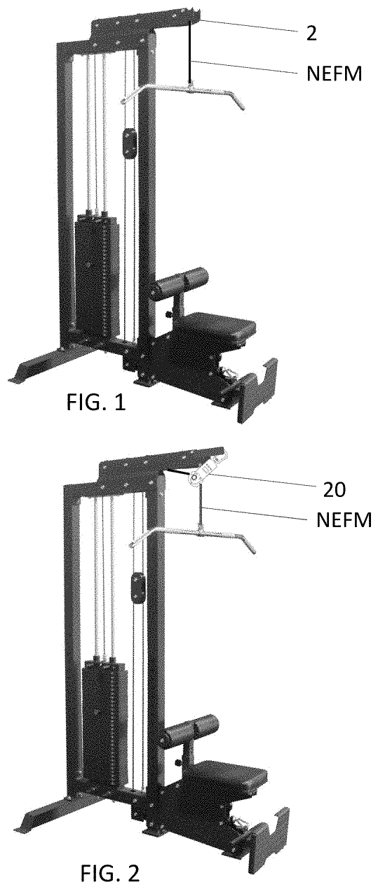

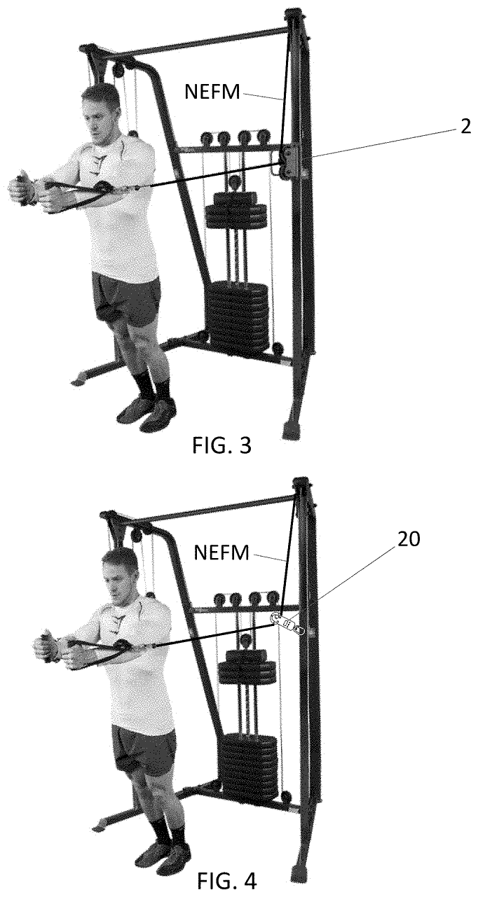

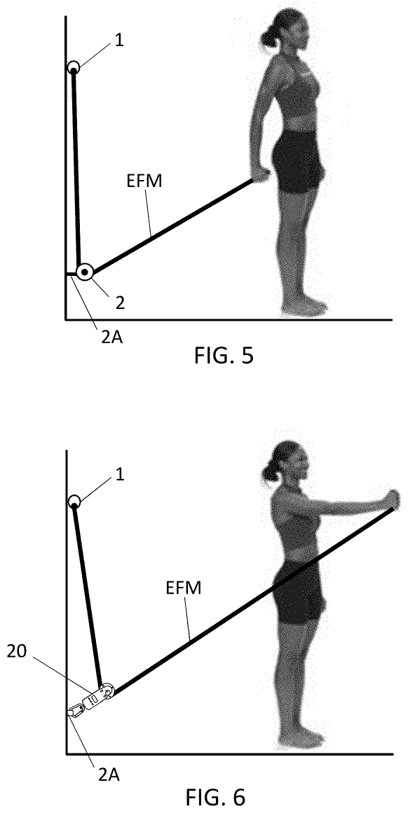

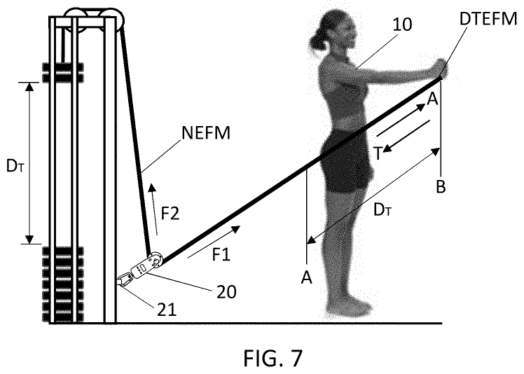

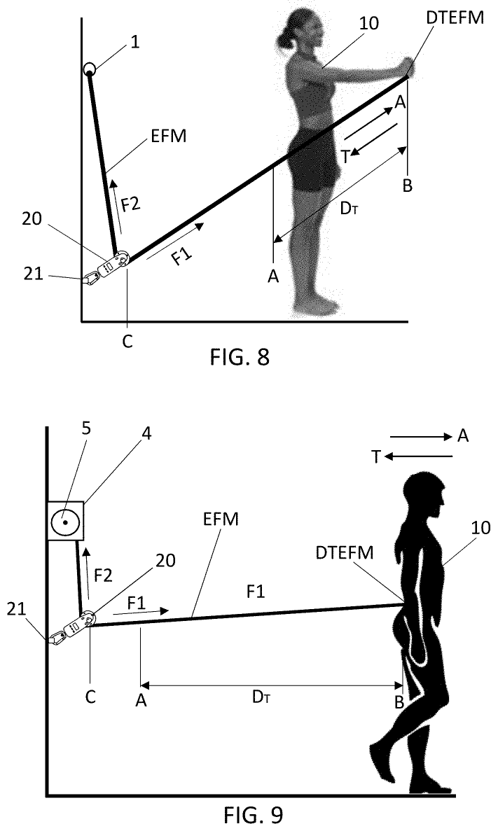

### DETAILED DESCRIPTION OF THE PREFERRED EMBODIMENTS

A invention that can be integrated with an flexible member and attached to a fixed object providing the means to measure and calculate various exercise parameters associated with movement of and load applied by the distal training end of an flexible member (DTEFM) attached to a trainee. The device will be able to measure, calculate and store as a function of time, how far the trainee moves the DTEFM or distance trained, the velocity of the DTEFM and training load applied to the trainee by the DTEFM for every training movement away from or towards the device. The device will be able calculate and present other important training parameters associated with the trainee's movement of the DTEFM such as maximum exercise velocity, acceleration and power generated for every training movement including the total work performed and calories burnt for every training movement and for a complete training session. The device will have wireless capabilities so that it may have 2-way communication and control with an independent processing unit such as a smart phone, iPad or PC whereby any portion of the measured data can be transmitted to and processed by an independent processing unit through an App. The App in conjunction with the invention will be able to communicate with the trainee to guide the trainee or trainees through workouts consisting of many exercises. All measurement data over multiple workouts for an individual can be stored and analyzed over time to track training progress of the trainee and the effectiveness of the training protocol over time.

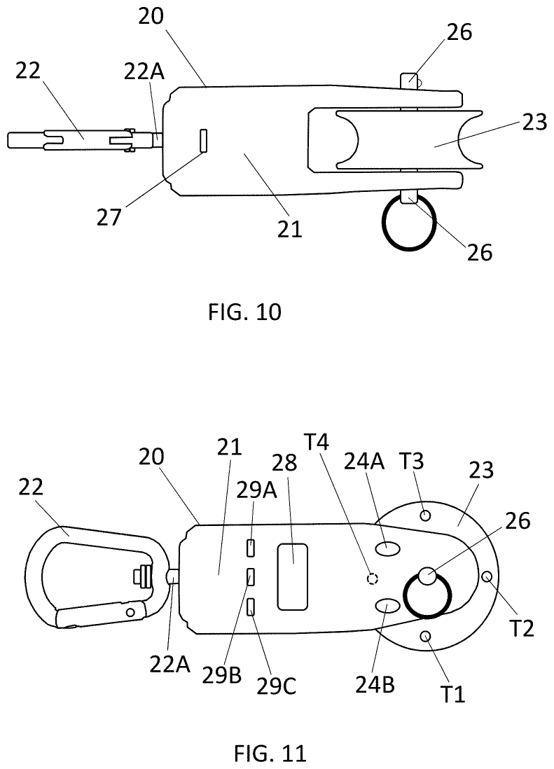

FIGS. 10-11 illustrate two side view perspectives of the device 20 offset by 90 degrees showing a housing 21, pulley 23 with support pin 26 and mount 22 to attach the device 20 to a stationary object. Member 22A provides connectivity between mount 22 and the internal force (tension) sensor in housing 21. Members 29A, 29B and 29C illustrate manual control and On/Off buttons while member 28 shows an LCD Status and Control display. T1, T2, T3 and T4 are magnetic targets embedded in pulley 23 so that rotational sensor 24A or sensors 24A and 24B can measure the speed of rotation of pulley 23 as well as complete and fractional rotations of the pulley 23. Member 26 is a retaining pin to hold the removable pulley in place. There are numerous other embodiments of the proposed device. The referenced drawings show mount member 22 as a spring clip with the ability to open and clip onto a suitable stationary object. Member 22 could include a number of different embodiments including a continuous ringlet that does not open or receptors designed to snap or join together with another receptor which connects device 20 to a fixed object. The manual control and ON/Off buttons 29A, 29B and 29C located on device 20 may be as few as a single button. Member 28 illustrating an LCD indicator could be single multicolor LED to indicate On/Off status, wireless sync status, battery level and Ready status. The referenced figures illustrate the use of magnets targets T1-T4 and sensors 24A and 24B to sense magnetic fields through induction to measure rotation characteristics of pulley 23. Other means to measure rotational characteristics of pulley 23 could include optical sensors used with optical targets, rotary potentiometers, differential transformers and inductive capacitance sensors. Rotational characteristics of pulley 23 could also be measured with a single sensor instead of using multiple sensors 24A and 24B.

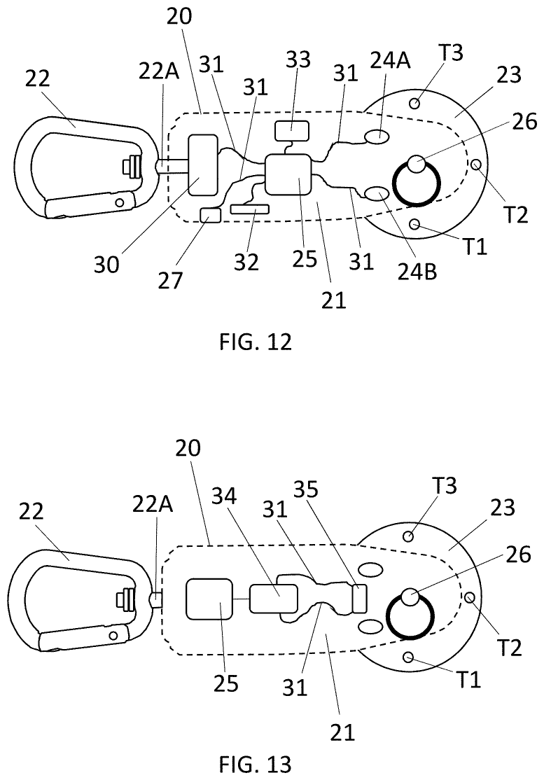

FIGS. 12 and 13 illustrate device 20 with a transparent housing 21 so that primary components within the housing can be identified. Illustrated is processing unit 25 with connectivity 31 to the following components; rotation sensors 24A and 24B, force sensor 30, level sensor 32, communication module 33 and member 27 which is the charging and computer interface port. Not shown are the interfaces between the processing unit and indicator member 28 and command and control members 29A-29C. FIG. 13 shows the charging device 35 with connectivity 31 to the battery 34 which has connectivity to processing unit 25. Member 35 is adapted to react to rotating targets T1-T4 to create electrical current to charge battery 34. Another embodiment to increase charging efficiency includes modifying housing 21 to expand its physical coverage over pulley 23 so that multiple charging devices 35 may be positioned to react to multiple targets T1-T4 simultaneously.

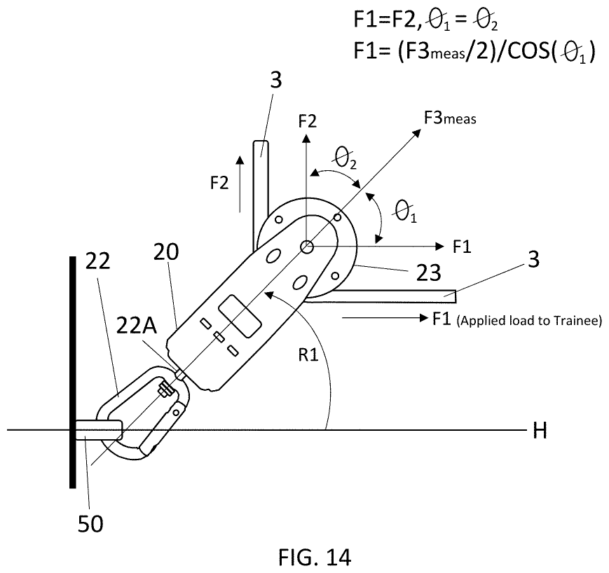

FIG. 14 illustrates when force is applied to flexible member 3, force vector F1 applying training load directly to the trainee will be equal in magnitude to force vector F2 directed toward the flexible member anchor point. Flexible member 3 tension will result in equal force vectors F1 and F2 which will cause device 20 to rotate away from horizontal axis reference H in the radial direction of R1 to a point of equilibrium. Angles Theta₁ and Theta₂ will be equal due to force vectors F1 and F2 being of equal magnitude. Level sensor 32 will measure angle Theta₁ and tension sensor 30 will measure the force applied to 22A along the F3ₘₑₐₛ reference axis. The training load F1 applied to the trainee by flexible member 3 will be calculated using the known F3ₘₑₐₛ force component as measured by the tension sensor using the following equation: F1=(F3ₘₑₐₛ/2)/Cos(Theta₁).

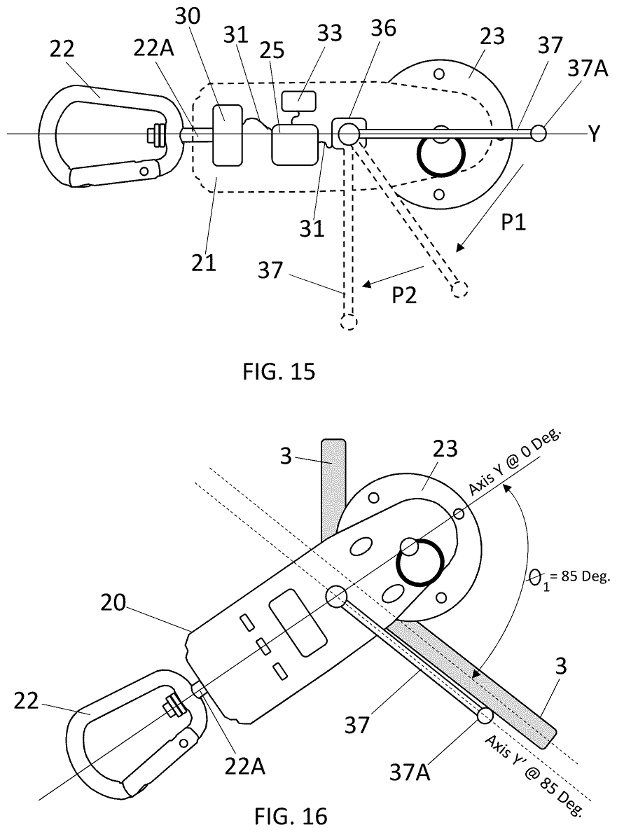

FIGS. 15-16 illustrate how the exit angle Theta₁ can be resolved using another embodiment whereby a spring loaded lever arm 37 with extension member 37A extending away from the viewer just past the far side of pulley 23 so that as flexible member 3 exits pulley 23, flexible member 3 will come in contact with member 37A and apply force to lever 37 in the direction of Vectors P1 and P2 driving lever 37 in the clockwise direction. With no load applied to member 37A, the spring-loaded lever 37 will always be driven toward a stop position resting on axis Y. When tension forms in flexible member 3 and a training load is applied to the trainee, the Y axis of the measuring device will rotate counterclockwise and flexible member 3 exiting pulley 23 in a direction towards the trainee will come in contact with member 37A driving member 37 clockwise relative to the Y axis. Position sensor 36 connected to lever 37 will determine angle Theta₁ based on the angular difference between the Y axis of the measuring device and the Y′ axis defined by member 37. FIG. 16 shows an example of lever 37 being offset by flexible member 3 to a position of 85 degrees defining Theta₁. Position sensor 36 will resolve angle Theta₁ and send the information to the processing unit to calculate training load F1 force applied to the trainee using Theta₁ and F3ₘₑₐₛ data obtained from the tension sensor as indicated with FIG. 14.

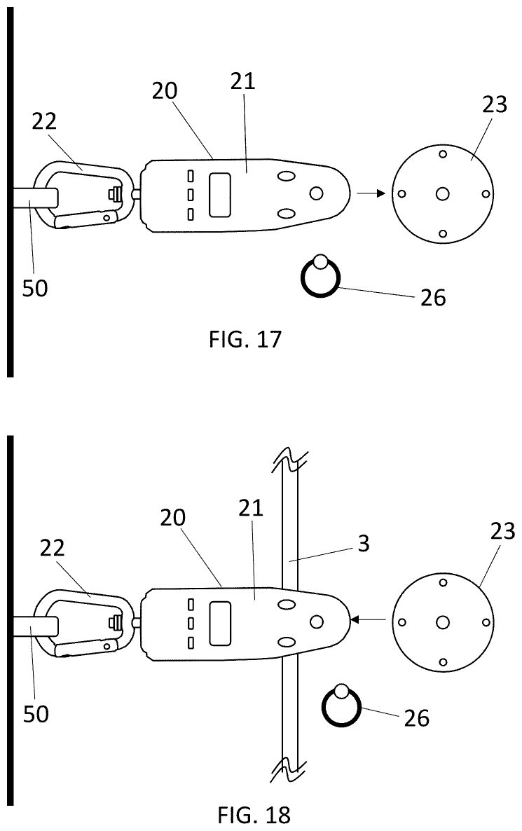

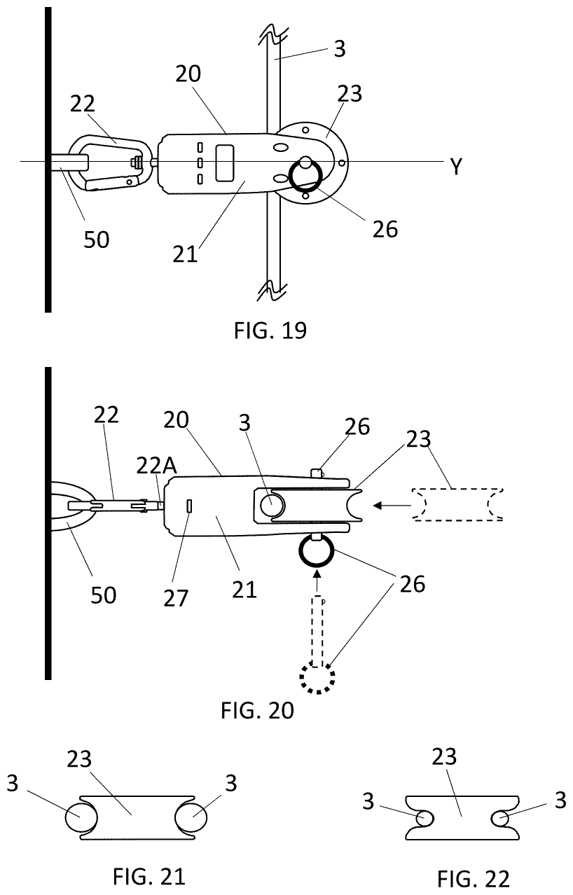

FIGS. 17-20 illustrate how pulley 23 is removable by extracting retention pin 26 thus allowing flexible member 3 to be inserted into housing 21 as shown in FIG. 18. As shown in FIG. 19 and FIG. 20, once pulley 23 is inserted back into housing 21 and the retention pin 26 is reinserted, flexible member 3 is integrated with the device 20. Other embodiments of 20 may include placing a hinge on one side of housing 21 so that one side portion of housing 21 which secures pulley 23 can open up (unfold) so that flexible member 3 can be inserted into the housing and then pulley 23 fixed to the hinged side of housing 21 can be folded shut and locked in place. While the hinged portion of housing 21 is open pulley 23 may be removed and replaced with another pulley 23.

FIGS. 21-22 illustrate how pulley member 23 groove may be adapted to accommodate flexible member 3 diameters of varying sizes. In the case of FIG. 22, a specially adapted groove that slightly compresses flexible member 3 is illustrated to better grab flexible member 3 so as to reduce the amount of slippage between pulley 23 and flexible member 3 which would otherwise induce error into distance trained measurements when slippage occurs causing pulley 23 to temporarily lose track of actual flexible member 3 movement away from or towards device 20.

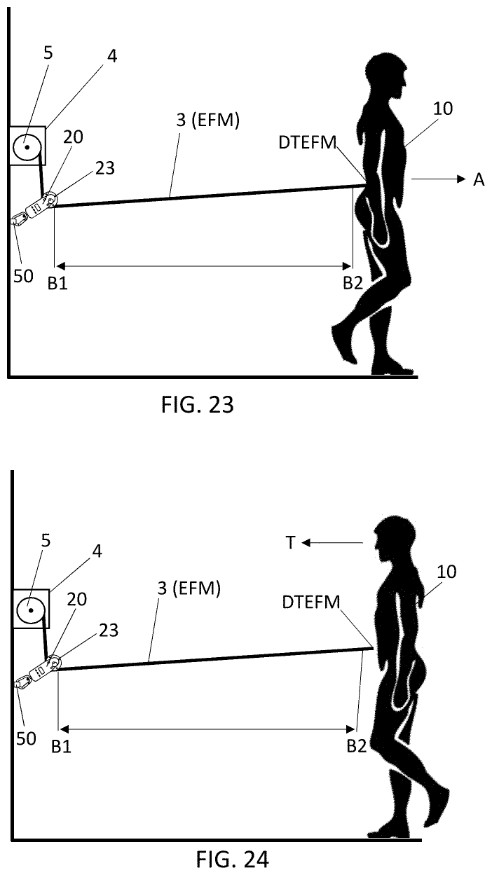

FIG. 23 illustrates that when flexible member 3 is an elastic flexible member (EFM), simply counting pulley rotations and multiplying rotations times the circumference of the pulley groove when the EFM is being extracted from pulley 23 by a trainee moving in direction A is not sufficient to make an accurate training distance calculation for trainee movement between points B1 and B2. The reason being as the distance between B1 and B2 increases and the fixed length 3 (EFM) is stretched further, tension in 3 (EFM) will increase and all elastic elements between points B1 and B2 will actively elongate as tension increases as a function of the trainee's increasing distance from device 20. Pulley 23 will not be additionally rotated by elongations that occur in 3 (EFM) between points B1 and B2 after 3 (EFM) elements have exited pulley 23 (post pulley elongation). The device will use novel means to calculate the amount of elongation that occurs to 3 (EFM) after it exits pulley 23 in the direction of vector A to allow the accurate measurement of distance trained accounting for elongation when a trainee works against an EFM. Device 20 will be able to calculate an accurate training distance of a trainee moving from point B1 to B2 by recording the length of band exiting pulley 23 in the direction of vector A and then adding the estimated post pulley band elongation that actively occurs to that portion of 3 (EFM) between points B1 and B2 which is not accounted for by pulley rotations.

FIG. 24 illustrates the opposite scenario as described for FIG. 23 whereby simply counting pulley rotations and multiplying rotations times the circumference of the pulley groove while e (EFM) is being retracted into pulley 23 is not sufficient to make an accurate distance trained calculation between points B1 and B2 when trainee 10 has DTEFM of 3 (EFM) attached and is moving towards device 20 in the direction of vector T. The reason being as the distance between B1 and B2 decreases the tension in fixed length flexible 3 (EFM) will gradually decrease as a function of the trainee's distance from device 20 and all 3 (EFM) elements between B1 and B2 will shrink. Pulley 23 can't detect 3 (EFM) actively shrinking between points B1 and B2 prior to 3 (EFM) elements retracting and entering pulley 23 (pre pulley shrinkage). The device will use novel means to estimate the amount of pre pulley shrinkage that occurs to 3 (EFM) before it enters pulley 23 in the direction of vector T to allow accurate measurement of distance trained while a trainee is moving towards device 20 from point B2 to B1. The measurement will be accomplished by recording the length of band entering pulley 23 in the direction of vector T and then adding the estimated shrinkage that actively occurs to that portion of band 3 between points B1 and B2 as tension in 3 (EFM) actively decreases while the trainee moves from point B2 to B1.

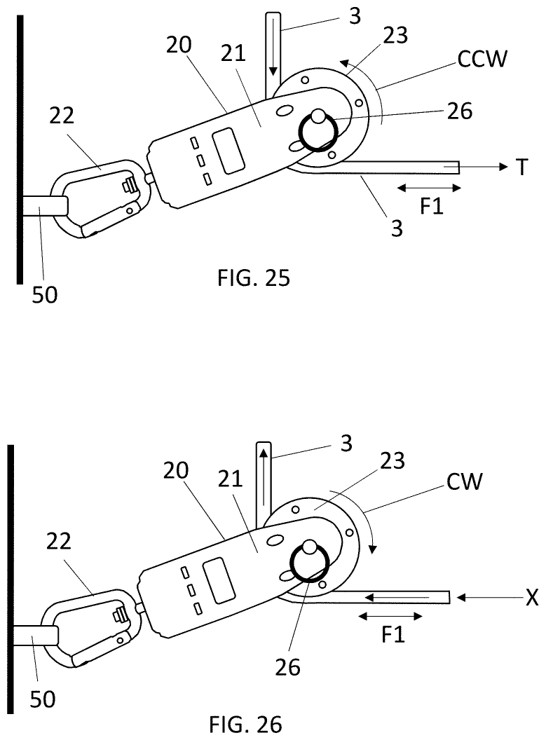

FIG. 25 illustrates how pulley 23 will be driven in the counterclockwise direction CCW by flexible member 3 movement in the direction of vector T. Processing unit 25 will calculate how far the trainee moves away from device 20 using two components to determine distance trained for trainee movements moving away from device 20. The first and only component required to compute the distance trained away from device 20 when flexible member 3 is a non-elastic flexible member (NEFM) will be using a direct measurement of the amount of flexible member 3 length exiting pulley 23 towards the trainee in the direction of vector T. Determining the amount of flexible member 3 length exiting pulley 23 while a trainee is attached to flexible member 3 and moving away from device 20 is accomplished by multiplying the circumference of pulley member 23's inner groove times the complete plus fractional number of pulley 23 rotations in the counterclockwise direction providing a result equaling the physical length of NEFM that the trainee has extracted from pulley 23 equaling the exact distance trained away from device 20. When using an elastic flexible member (EFM), device 20 as second calculated component estimating elongation length has to be added to the first component which calculated distance trained by simply counting pulley rotations and multiplying times circumference. Again, the reason being band elongation occurred between pulley 23 and the trainee during the flexible member extraction which pulley 23 could not track. The second component of the distance trained measurement when using an EFM is calculating how much that portion of EFM between pulley member 23 and the trainee elongates after elements of flexible member 3 exit pulley 23. This second component (post pulley elongation) must be added to the first component (physical length of flexible member 3 exiting pulley 23) to more accurately calculate the total distance trained for any contiguous movement of the trainee away from device 20. The second component (post pulley elongation) is calculated using an elasticity coefficient table that characterizes how much the EFM stretches as a percentage of it's length under various loads. As incremental portions of a predefined length of EFM exits pulley 23, the current degree of stretch or a “stretch factor” will be assigned to each incremental portion of EFM length based on the tension F1 (calculated using the tension measurement on axis F3ₘₑₐₛ and measured angle Theta₁) the incremental length of band is subjected to as it leaves pulley 23. As the trainee moves away from device 20 further stretching the fixed length EFM, the tension in flexible member 3 will inherently increase as flexible member 3 is stretched with one end anchored to a fixed object and the other attached to the trainee moving away from device 20. Consequently, all incremental portions of flexible member 3 that have already exited pulley 23 will be subjected to an increase in tension and will elongate as a function of the EFM's elasticity coefficient and the increased tension (F1) in flexible member 3 as it is stretched further. An algorithm will be utilized to estimate the additional length each incremental portion of flexible member 3 with an assigned stretch factor between points B1 and B2 stretches. The difference between the assigned stretch factor when the incremental EFM portion exited pulley 23 and the real time tension (F1) as it relates to a stretch factor on the elastic coefficient table will determine the additional stretch distance of any given incremental portion of EFM between pulley 23 and the trainee. The instantaneous additional stretch length of each incremental portion of elastic flexible member 3 between pulley 23 and the DTEFM will be summed and added to the extracted band length pulley 23 is measured with the first measurement component providing an accurate distance trained measurement as a function of time that includes EFM elongation during the training movement.

FIG. 26 illustrates how pulley 23 will be driven in the clockwise direction CW by flexible member 3 movement in the direction of vector X when the trainee connected to flexible member 3 is moving towards device 20 in the direction of vector X. The process used in the FIG. 25 explanation to calculate the estimated distance trained away from device 20 will be used in a reverse manner to calculate estimated training distance towards device 20. When using a NEFM the distance trained towards the invention requires only one measurement component whereby distance trained is accurately calculated multiplying pulley 23 rotations times the circumference of the pulley. If an EFM is used as flexible member 3 then a second component estimating EFM shrinkage prior to entering pulley 23 must be calculated using a similar method described for FIG. 25 but in reverse. The amount of EFM shrinkage must be added to the first calculated component using pulley 23 rotations to calculate the distance trained towards device 20 in the direction of vector X.

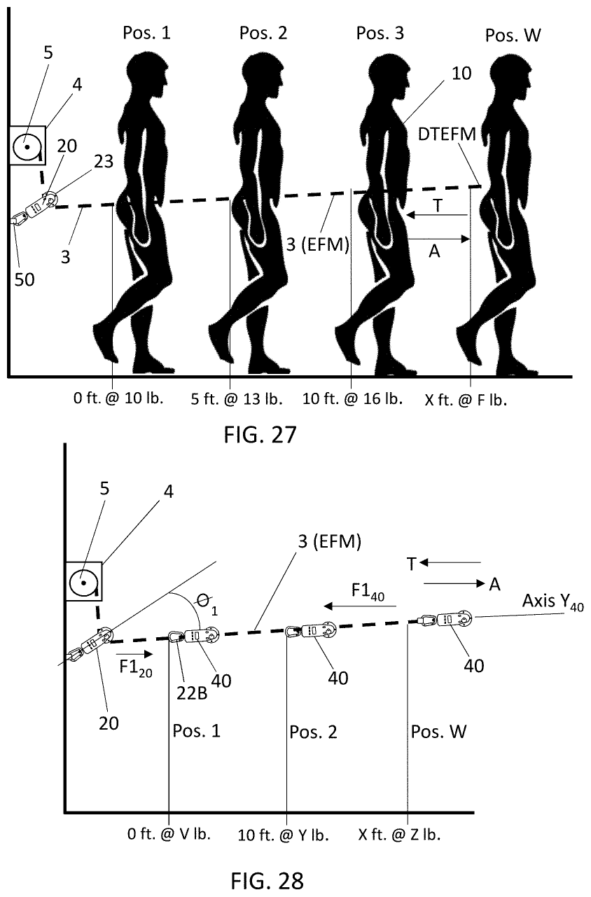

FIG. 27 illustrates a first calibration method that will allow device 20 to calculate an accurate distance trained without the use of an elasticity coefficient table when flexible member 3 is an EFM. Whereby the trainee 10 connects 3 (EFM) to their body and places themselves in Pos. 1 with a desired starting resistance of 10 lb. with the starting reference point Pos. 1 designated to be 0 ft. Device 20 measures and records the training load of 10 lb. and then through audio or visual means or through the use of an App on an independent smart device communicating with the trainee, can instruct the trainee to move in the direction of vector A to a sequence of reference points of known distance from the starting reference point Pos. 1. Those points consisting of positions Pos. 2 thru Pos. W. In this case the trainee moves to Pos. 2 which is 5 feet from the starting reference point Pos. 1 @ 0 feet and pauses while device 20 counts the complete and fractional pulley 23 rotations associated with the trainee moving 5 feet from the reference point Pos. 1 to Pos. 2. Device 20 also measures the training load 13 lb. (F1) at Pos. 2. The trainee is then instructed to move to the next reference point Pos. 3 at 10 feet from the referenced starting point where the additional complete and partial pulley 23 rotations associated with moving from 5 feet to 10 feet are recorded along with training load 16 lb. (F1). This process can be repeated multiple times out to Pos. W. It can then be reversed having the trainee sequentially move back towards device 20 in the vector T direction stopping at the same reference points. Once pulley 23 rotations and measured training loads F1 are associated with the trainee being at specific distances from the reference starting point Pos. 1 out to Pos. W, post pulley band elongation and post pulley band shrinkage will be calibrated into the pulley rotations without the use of an elastic coefficient table. Device 20 will now have the ability to monitoring pulley 23 rotations and relate the rotations to the rotations vs distance table generated by the calibration procedure to accurately estimate where the trainee is relative to reference Pos. 1 at any given point in time providing device 20 the ability to calculate distance trained including the velocity of the DTEFM during the complete training movement without having to reference an elastic coefficient table foe the EFM.

FIG. 28 illustrates a second calibration method to reduce measurement errors when using an EFM is utilizing a second member 40 identical to device 20 and attaching member 40 to the DTEFM using member 22B of member 40 so that member 40 can measure the exact training load F1₄₀ applied to the trainee at any given point in the calibration path used in FIG. 27. The trainee is instructed visually or by audio to sequentially move away from device 20 to reference points of increasing, known distances, As with the first said calibration method, complete and fractional pulley rotations will be associated with the movement from the referenced starting point Pos. 1 out to each additional reference point thru Pos. W to account for post pulley band elongation moving away from device 20 and pre pulley shrinkage moving towards device 20. The advantage of this second calibration method is that the member 40 can measure the actual training load F1₄₀ directly in line with the Y axis of device 20 per FIG. 19 and then transmit it to device 20 without potential errors being introduced by having to resolve the F1 force vector from a tension measurement on the F3meas axis and resolve (measure) the Theta1 angle shown in FIG. 15 since the Theta₁ angle is 0 degrees offset relative to axis Y₄₀ of FIG. 28. Device 20 can instantaneously compare the F1₂₀ training load measurement it derived from the F3ₘₑₐₛ force measurement and Theta₁ (see FIG. 15) against the actual training load F1₄₀ measured by member 40 at the DTEFM. Device 20 will then use the actual training load value F1₄₀ received by device 20 as a true training load reference to detect errors in it's F1₂₀ force measurement and thus calibrate out errors in measurements associated with determining Theta₁ and measuring F3ₘₑₐₛ. Once the calibration procedure is completed the trainee can detach device 40 from the distal training end of elastic band 3 and attach band 3 to their body, position themselves at Pos. 1 and begin training. Device 20 will then use the calibration data to more accurately measure distance trained and the velocity of the distal training end of flexible member 3 by simply tracking complete and partial pulley rotations in both the CCW and CW directions related to the starting reference position Pos. 1.

1. A system for use with an exercise device, the device comprising:
a housing;
a flexible member;
a pulley rotatably mounted to the housing, the pulley adapted to be rotated by the flexible member;
a rotation sensor mounted to the housing for measuring the speed of rotation of the pulley and producing an output;
a processing unit having a timer, the processing unit adapted to receive the output from the rotational sensor, the processing unit using the timer and output from the rotational sensor to compute rotational velocity of the pulley.

2. The system of claim 1, further comprising a tension sensor connected to the pulley and producing an output representative of the force applied to the pulley.

3. The system of claim 2 further having a level sensor mounted in the housing for producing an output representing the angle of the pulley with respect to a horizontal axis, the processing unit connected to the level sensor to compute a vector in a direction of travel of the flexible member from the pulley.

4. The system of claim 1 further having a communication module for wirelessly transmitting the output from the rotational sensor to the processing unit.

5. The system of claim 1, further comprising a display for displaying information from the processing unit.

6. The system of claim 1, further comprising at least one target mounted to the pulley.

7. The system of claim 6, wherein the at least one target is a magnet.

8. The system of claim 1, further comprising a battery and a charging device wherein the charging device is adapted to react to the target to create electrical current for charging the battery.

9. The system of claim 1, wherein the pulley is mounted to the housing by a ring.

10. The system of claim 1, wherein the ring is a spring loaded snap link.

11. A system for creating data for a user of a flexible member, the system comprising:
a housing;
a pulley connected to the housing to be rotated by the flexible member;
a rotational sensor connected to the housing for measuring the speed of rotation of the pulley;
a processing unit having a timer, the processing unit receiving output from the rotational sensor to compute the rotational velocity of the pulley;
a remote unit having a display; and
a communication module mounted in the housing for delivering output from the rotational sensor or the processing unit to the remote unit.

12. The system of claim 11, further comprising a force sensor connected to the mount for measuring the force applied to the pulley by the flexible member.

13. The system of claim 12, further having a level sensor mounted in the housing for producing an output representing the angle of the housing with respect to a horizontal axis, the processing unit connected to the level sensor to compute a vector in a direction of travel of the flexible member from the pulley.

14. The system of claim 11, wherein the mount is a ring.

15. The system of claim 11 further wherein the flexible member is an elastic band, wherein the processing unit has a look up table containing a elasticity coefficient for the band, the processing unit using the timer, rotational velocity from the sensor and the elasticity coefficient to calculate the distance that the band elongates.

16. The system of claim 14 whereby the processor computes an estimated distance band shrinkage using the elasticity coefficient of the band.

17. A method of producing performance information for an exercise device having an elastic band passing over a pulley, the method comprising the steps of:
selecting a start position for an end of the elastro band;
moving the end of the band a predetermined known distance to a second position;
counting the revolutions of the pulley during movement of the band from the start position to the second position;
computing the distance traveled by using the number of revolutions counted during movement of the band;
computing performance information using the distance travelled and time elapsed during movement between the start position and second position.

18. The method of claim 17 further comprising the step of correcting the distance travelled during movement by correcting the distance for stretch in the band.

19. The method of claim 18 wherein the correction factor is computed using the elasticity coefficient of the band.

20. The method of claim 18 wherein the correction factor is calculated by measuring the actual distance from the start to the second position and company the actual distance to the computer distance.
